(19) United States
(12) Patent Application Publication
(10) Pub. No.: US 2015/0276092 A1
(43) Pub. Date: Oct. 1, 2015

(54) ENHANCED CORROSION RESISTANT CHANNELS, FITTINGS AND FASTENERS

(71) Applicant: Unistrut International Corporation, Wayne, MI (US)

(72) Inventors: Timothy R. Oliver, Cedar Lake, IN (US); Jacob R. Shaw, Chicago, IL (US); Darin Gleason, Green Oaks, IL (US)

(73) Assignee: Unistrut International Corporation, Wayne, MI (US)

(21) Appl. No.: 14/633,219

(22) Filed: Feb. 27, 2015

Related U.S. Application Data
(60) Provisional application No. 61/970,953, filed on Mar. 27, 2014.

(51) Int. Cl. F16L 3/24; F16L 3/26; F16B 7/18; F16B 7/04; F16B 7/10

(52) U.S. Cl. CPC F16L 3/24; F16B 7/04; F16B 7/10; F16B 7/18; F16L 3/26

(57) ABSTRACT

A corrosion resistant support system includes a first channel member having a first corrosion resistant coating. The first corrosion resistant coating is a zinc-aluminum-magnesium coating. A fitting is engageable with said channel member and a first mechanical fastener to couple the fitting to the channel member, the fitting and the first mechanical fastener having a second corrosion resistant coating. The second corrosion resistant coating is a thermal diffusion galvanized coating or a zinc-aluminum-magnesium coating. The first channel member and the first mechanical fastener may also have a third corrosion resistant coating disposed over the first and second corrosion resistant coatings, respectively. The third corrosion resistant coating can be a Perma-Green™ coating, a powder coating, an electrocoating (E-coat or Electrophoretic deposition coating), a paint coating, an epoxy coating, a polyvinyl chloride (PVC) coating, a trivalent chromium coating, a hexavalent chromium coating, a zinc coating, and/or a copper coating.

### CROSS-REFERENCE TO RELATED APPLICATIONS

This is a non-provisional of pending U.S. Provisional Patent Application Ser. No. 61/970,953, filed Mar. 27, 2014, titled “Corrosion Resistant Channels, Fittings and Fasteners”, the entirety of which provisional application is incorporated herein by reference.

### FIELD OF THE DISCLOSURE

The disclosure generally relates to metal framing systems, and more particularly to a corrosion resistant coating scheme for metal framing channels and fittings.

### BACKGROUND OF THE DISCLOSURE

Channel, e.g., UNISTRUT is formed strut used as support structures and bracing members in a variety of applications and industries. Channel is produced in a variety of sizes and steel gages depending on the application. Frequently, channel is formed with holes or slots to facilitate securing sections of channel with one another and for securing channel to walls and other structures or appurtenances. Channel can be secured to existing structures, to other channels, and to structures being supported using threaded rod, washers, nuts and the like. For example, the end of a threaded rod can be inserted through a slot in the channel whereupon a washer and nut are secured to the end thereof. The washer and nut prevent the rod from being withdrawn through the slot in the channel. The rod can be used to support the channel from an overhead structure, or it can be used to support an object below. A variety of fittings can be used with channels to create complex support structures to suit a particular application.

As will be appreciated, many of the applications in which such channel, fittings and fasteners are used are outdoors, where they can be subject to wind, rain, snow, salt spray, sun, and the like. Corrosion of channel, fittings and fasteners is a problem that can result in premature replacement of those components, and in the worst case can cause system structural failure.

To combat this, channels and fittings are typically galvanized to resist corrosion of the steel substrate, while fasteners are often formed from stainless steel materials to resist corrosion. Galvanizing, however, does not provide a desired long life for channel and fittings, while stainless steel is expensive.

In view of this, there remains a need for an improved system for reducing corrosion of metal framing system components, including channel, fittings and fasteners.

### SUMMARY OF THE DISCLOSURE

A corrosion resistant support system is disclosed, comprising a first channel member; a fitting engaged with said channel member; and a first mechanical fastener coupling the fitting to the channel member. In some embodiments, the first channel member comprises steel having a zinc-aluminum-magnesium coating. In some embodiments, the fitting and the first mechanical fastener comprises steel having a thermal diffusion galvanized coating. The support system may further include a second channel member coupled to the first channel member via said fitting and a second mechanical fastener, where the second channel member is steel having said zinc-aluminum-magnesium coating and the second mechanical fastener is steel having said thermal diffusion galvanized coating. The fitting may be selected from the list consisting of a beam clamp and conduit support. The mechanical fastener may be selected from the list consisting of a nut, a cap screw, a bolt, a channel nut, a coupler nut, a threaded rod, and a lock washer.

A corrosion resistant support system is disclosed, comprising a plurality of steel support members having a zinc-aluminum-magnesium coating, and a plurality of fittings and mechanical fasteners having a thermal diffusion galvanized coating. The corrosion resistant support system may be selected from the list consisting of a cable tray and a telescoping channel.

A corrosion resistant support system is disclosed, comprising a first channel member having a first corrosion resistant coating, the first corrosion resistant coating comprising a zinc-aluminum-magnesium coating. A fitting may be engageable with said channel member and a first mechanical fastener for coupling the fitting to the channel member. The fitting and the first mechanical fastener may each have a second corrosion resistant coating, the second corrosion resistant coating comprising a thermal diffusion galvanized coating. The first channel member and the first mechanical fastener may further have a third corrosion resistant coating disposed over the first and second corrosion resistant coatings, respectively. In some embodiments the third corrosion resistant coating is selected from the list consisting of a Perma-Green™ coating, a powder coating, an electrocoating (E-coat or Electrophoretic deposition coating), a paint coating, an epoxy coating, a polyvinyl chloride (PVC) coating, a trivalent chromium coating, a hexavalent chromium coating, a zinc coating, and a copper coating.

The support system may further include a second channel member coupled to the first channel member via said fitting and a second mechanical fastener. The second channel member may include the first and third corrosion resistant coatings thereon, and the second mechanical fastener may have the second and third corrosion resistant coatings thereon. In some embodiments, the fitting is selected from the list consisting of a beam clamp and a conduit support. The mechanical fastener may be selected from the list consisting of a nut, a cap screw, a bolt, a channel nut, a coupler nut, a threaded rod and a lock washer.

A corrosion resistant support system is disclosed, including a plurality of steel support members having a zinc-aluminum-magnesium coating, and a plurality of steel mechanical fasteners and a plurality of steel fittings having a thermal diffusion galvanized coating. The plurality of steel support members may include a third corrosion resistant coating applied over the zinc-aluminum-magnesium coating. The plurality of steel mechanical fasteners and the plurality of steel fittings may include the third corrosion resistant coating applied over the thermal diffusion galvanized coating. The corrosion resistant support system may be selected from the list consisting of a cable tray and a telescoping channel.

### BRIEF DESCRIPTION OF THE DRAWINGS

By way of example, a specific embodiment of the disclosed device will now be described, with reference to the accompanying drawings:

FIGS. 1-2 are isometric views of exemplary channel members according to embodiments of the disclosure;

FIG. 3 is an isometric view of an exemplary pipe/conduit support according to embodiments of the disclosure;

FIGS. 4-7 are isometric views of a pair of exemplary general fittings according to embodiments of the disclosure;

FIG. 8 are isometric views of exemplary beam clamps according to embodiments of the disclosure;

FIG. 9 are isometric views of exemplary channels nuts according to embodiments of the disclosure;

FIG. 10 are isometric views of an exemplary coupler nut and threaded rods according to embodiments of the disclosure;

FIG. 11 is an isometric view of an exemplary pipe/conduit support arrangement including certain of the fittings of FIGS. 1-10;

FIG. 12 are isometric views of exemplary channel members according to further embodiments of the disclosure;

FIG. 13 is a cross-section of one of the exemplary channel members of FIG. 12 taken along line 13-13 of FIG. 12;

FIG. 14 is an isometric view of an exemplary pipe/conduit support according to further embodiments of the disclosure;

FIG. 15 is a cross-section of the exemplary pipe/conduit support of FIG. 14 taken along line 15-15 of FIG. 14; and

FIG. 16 is an isometric view of an exemplary pipe/conduit support arrangement according to further embodiments of the disclosure.

### DETAILED DESCRIPTION

A corrosion resistant support structure is disclosed comprising corrosion resistant channels, corrosion resistant fittings and corrosion resistant fasteners. The channels, fittings and fasteners comprise carbon steel, and are provided with improved coatings for preventing corrosion of the strut members and fittings in harsh service conditions. This represents an advantage over prior art systems because it eliminates the need for stainless steel fasteners and/or other inherently corrosion resistant base materials.

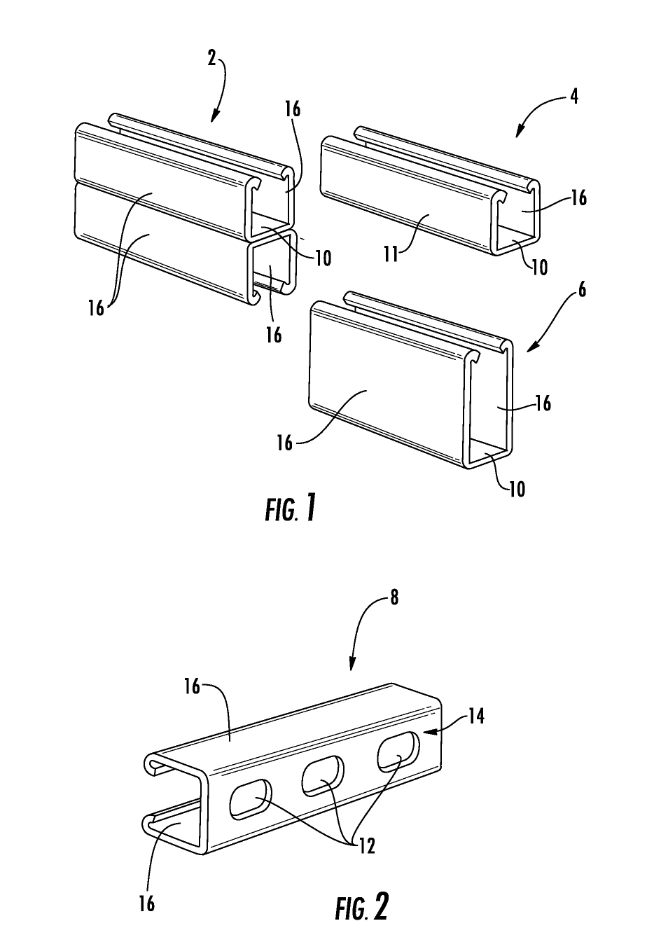

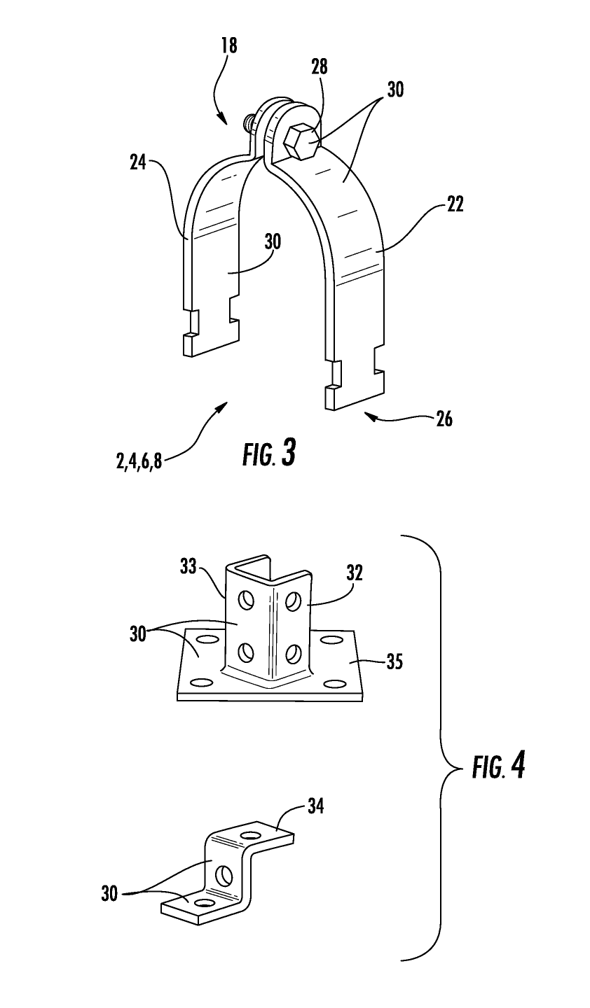

FIGS. 1-2 show exemplary channel members 2, 4, 6, 8. The channel members 2, 4, 6 of FIG. 1 have solid webs 10, while the channel member 10 of FIG. 2 has a series of slots 12 formed in the web 14. As will be appreciated the slots 12 can receive fasteners and/or threaded rods for fixing the channel member 10 to other structure or for supporting objects (e.g., pipe, conduit) from the channel member 10.

The channel members 2-8 may have a first corrosion resistant coating 16 applied to some or all of the external surfaces of the members. In one embodiment, the first corrosion resistant coating 16 covers the entirety of the external surfaces of the channel members 2-8.

The first corrosion resistant coating 16 may be a zinc-aluminum-magnesium coating. One commercial version of the first corrosion resistant coating 16 is sold by Nisshin Steel Company, Ltd., under the trade name ZAM®. An advantage of the first corrosion resistant coating 16 is that it remains in what can be termed a “fluid” state after it is applied to the steel. As such, if the first corrosion resistant coating 16 is scuffed or scratched during manufacture, installation or use, it can self-heal. The first corrosion resistant coating 16 can be relatively thin, on the order of a few micro-inches, which is a distinct advantage over hot-dip galvanized coatings which can be three or more times as thick. An example of another appropriate embodiment of a first corrosion resistant coating 16 is sold by ArcelorMittal under the trade name Magnelis®.

In some embodiments the first corrosion resistant coating 16 may be applied to the steel base material before it is formed into the final shape of the channel members 2-8.

FIG. 3 is an exemplary pipe/conduit support fitting 18 which, as shown, can have first and second arms 22, 24, distal ends of which are configured to be received within a channel portion 26 one of the channel members 2-8. The first and second arms 22, 24 can be coupled at proximal ends thereof using a mechanical fastener 28, which in the illustrated embodiment is a nut/bolt combination. The individual elements of the support fitting 18, including the first and second arms 22, 24 and the mechanical fastener 28 can have a second corrosion resistant coating 30 applied to the external surfaces thereof.

In some embodiments, the second corrosion resistant coating 30 applied to the support fitting 18, including the mechanical fastener 28, is a thermal diffusion galvanized coating. The thermal diffusion galvanized coating can be applied after the individual pieces (the first and second arms 22, 24 and the mechanical fastener 28) are manufactured. Thus, the manufactured pieces of the support fitting 18 may have bare steel surfaces. The bare steel pieces can then be heated and simultaneously subjected to a zinc-rich environment, whereupon the thermal diffusion galvanized coating locks to the pieces in a tightly adherent fashion. An exemplary commercial version of an appropriate second corrosion resistant coating 30 is offered by Distek N.A. LLC, under the trade name ArmorGaly®. Alternatively, the second corrosion resistant coating 30 can be the same coating as used for the first corrosion resistant coating 16. Thus, in one embodiment the second corrosion resistant coating 30 is the Magnelis® coating sold by ArcelorMittal.

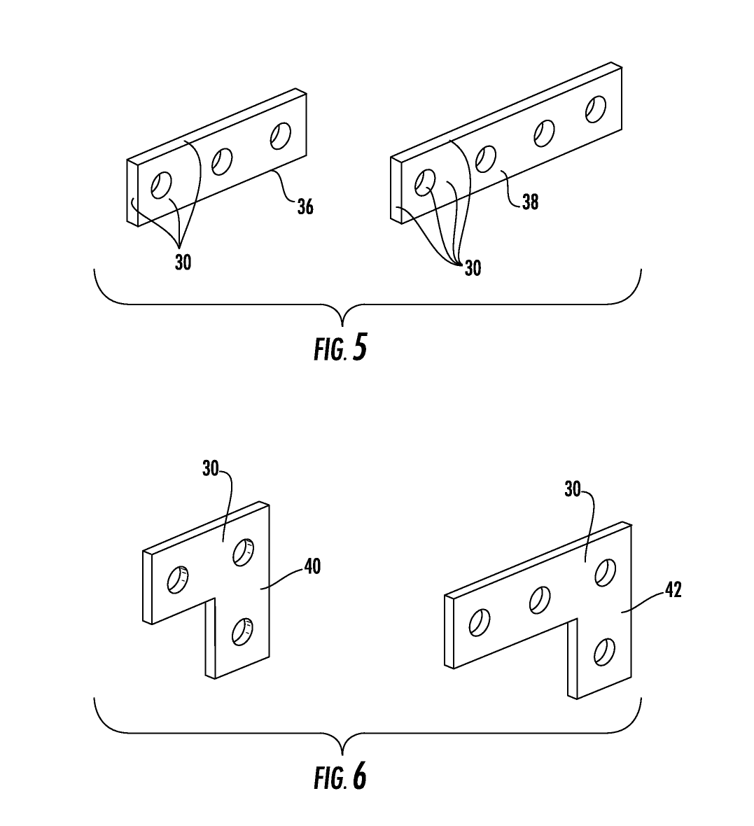

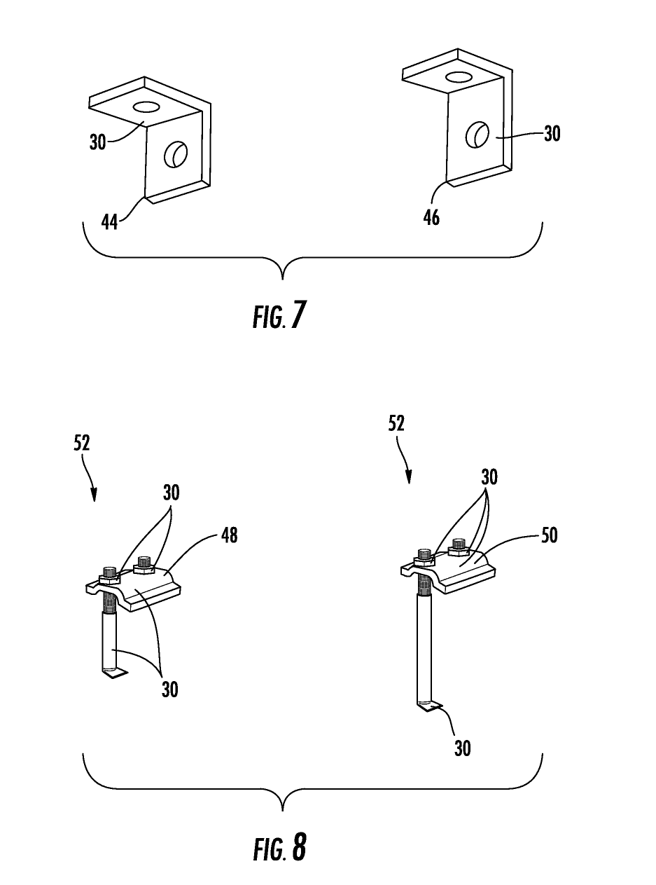

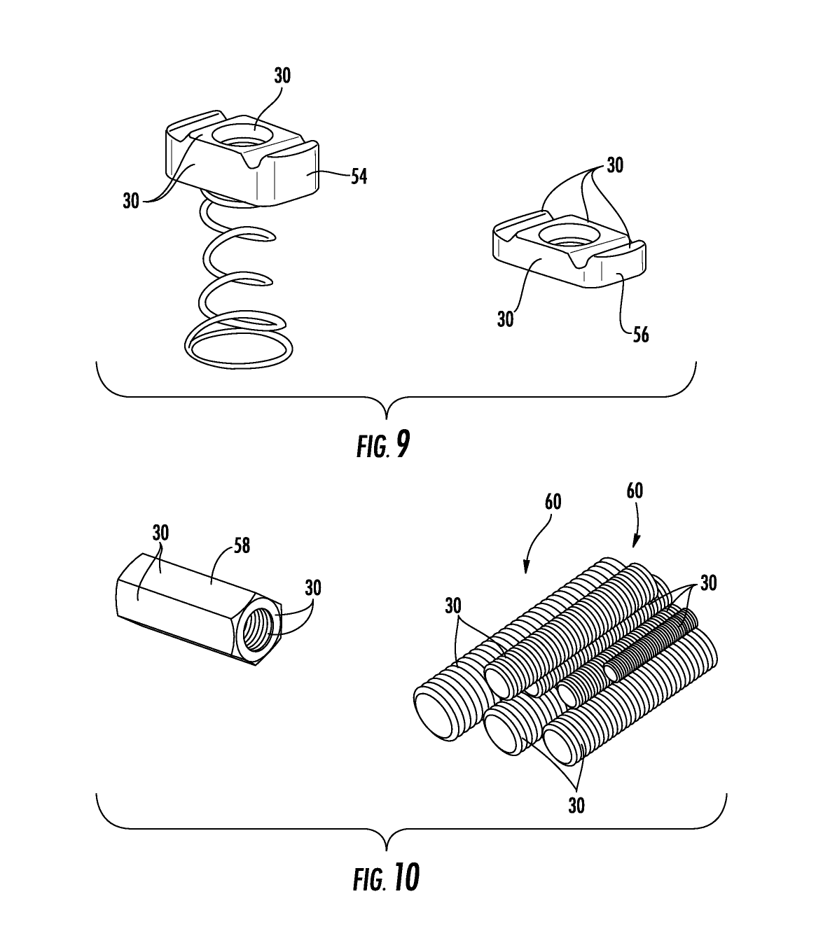

FIGS. 4-8 show additional exemplary fittings 32-50 that can be used with the disclosed channel members 2-8 according to the disclosure. FIG. 4 shows a pair of general fittings 32, 34 used for out of plane coupling of channel members 2-8. FIGS. 5 and 6 show exemplary plate fittings 36-42 which can be used for in-plane coupling of two or more channel members 2-8. FIG. 7 shows exemplary plate fittings 44, 46 used for in-plane or out-of-plane coupling of a pair of channel members 2-8. FIG. 8 shows exemplary beam clamp fittings 48, 50 for coupling one or more channel members 2 to an I-beam structure 52.

Each of these fittings 32-50 can be pre-fabricated from uncoated steel. The individual pieces may then have the corrosion resistant coating 30 applied using the aforementioned process. For example, the beam clamp 32 can be welded together (joining the channel portion 33 to the plate portion 35) prior to the corrosion resistant coating 30 being applied. Likewise, the various bends and holes of the fittings 32-50 may be made prior to applying the corrosion resistant coating 30.

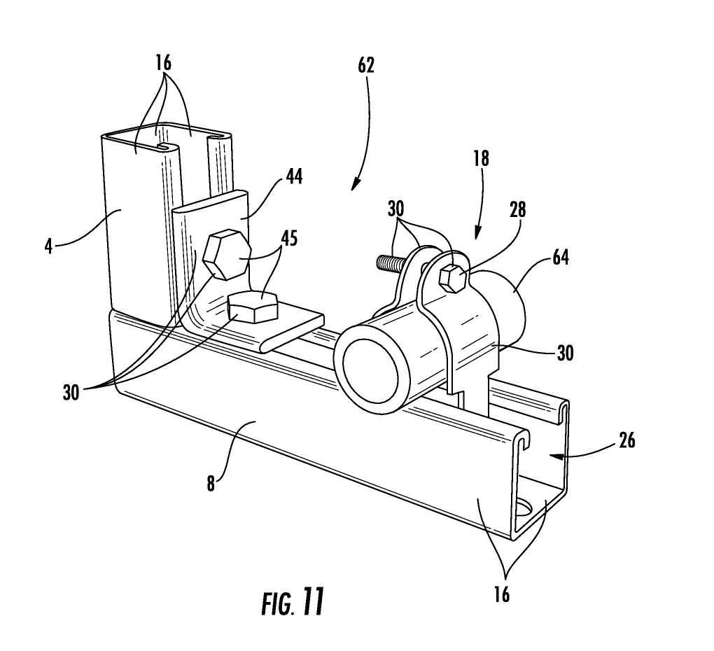

FIG. 9 shows a pair of exemplary channels nuts 54, 56 which can be used with the channel members 2-8 for coupling to another fitting or threaded rod. The exemplary channel nuts 54, 56 may be pre-fabricated, and may then have the corrosion resistant coating 30 applied using the aforementioned thermal diffusion galvanizing process so that the corrosion resistant coating is applied to all external surfaces of the channel nuts.

FIG. 10 shows an exemplary coupler nut 58 and threaded rods 60 which can be used for attaching various fittings to the channel members 2-8. The exemplary coupler nut 58 and threaded rods 60 may be pre-fabricated, and may then have the corrosion resistant coating 30 applied using the aforementioned thermal diffusion galvanizing process so that the corrosion resistant coating is applied to all external surfaces of the coupler nut and threaded rods, including the thread surfaces thereof. The advantage of using a thermal diffusion coating 30 in this application is that it has little or no effect on the threadability of the resulting threaded connections.

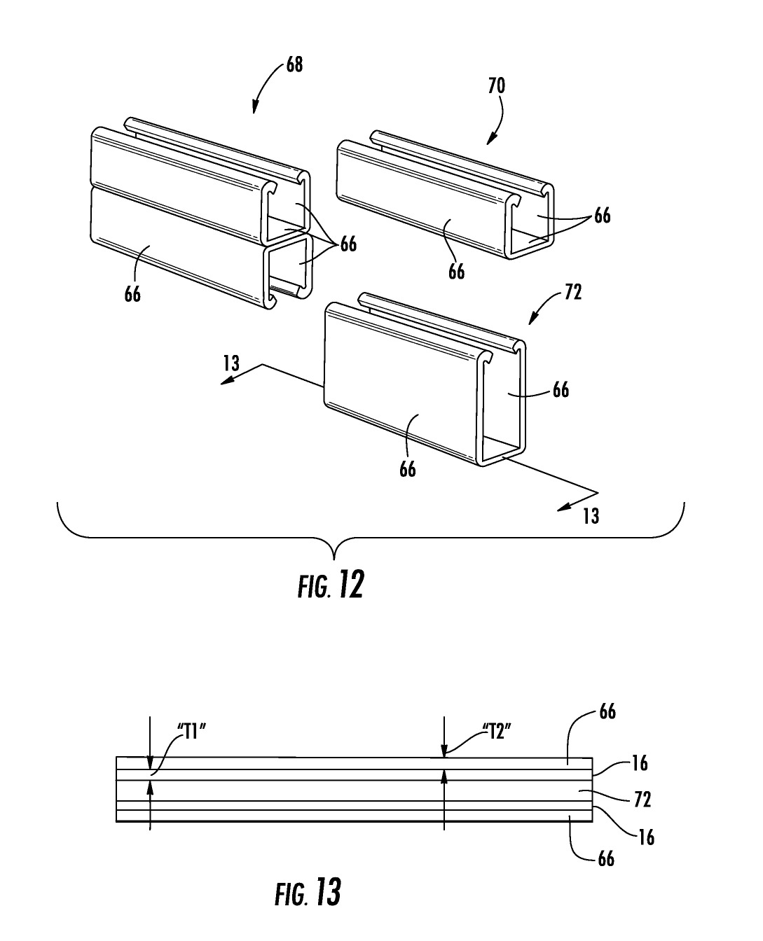

FIG. 11 shows an exemplary support assembly 62 for supporting a length of pipe/conduit 64. The support assembly 62 includes first and second channel members 4, 8, a plate fitting 44 coupling the first and second channel members at a 90-degree angle via mechanical fasteners 45 and first and second channel nuts (not visible). A support fitting 18, including the mechanical fastener 28, engages the channel portion 26 of the second channel member 8 to couple the pipe/conduit 64 thereto. The first and second channel members 4, 8 may include a corrosion resistant coating 16 on all exterior surfaces thereof. In one embodiment, the corrosion resistant coating 16 is a zinc-aluminum-magnesium coating. Likewise, the plate fitting 44, support fitting 18, first and second channel nuts and mechanical fasteners 28, 45 may all include a corrosion resistant coating 30 on all exterior surfaces thereof. In one embodiment, the corrosion resistant coating 30 is a thermal diffusion galvanizing coating.

FIGS. 12 and 13 show a further embodiment in which a third corrosion resistant coating 66 is applied over the first corrosion resistant coating 16 of a plurality of exemplary channel members 68, 70, 72. In some embodiments, the third corrosion resistant coating 66 is applied to some or all of the external surfaces of the first corrosion resistant coating 16.

In non-limiting exemplary embodiments the third corrosion resistant coating 66 may be a Perma-Green™ coating, a powder coating, an electrocoating (E-coat or Electrophoretic deposition coating), a paint coating, an epoxy coating, a polyvinyl chloride (PVC) coating, a trivalent chromium coating, a hexavalent chromium coating, a zinc coating, or a copper coating.

FIG. 13 shows a cross-section view of the coating buildup on an exemplary channel member 72. In some embodiments, the first corrosion resistant coating 16 may have a thickness T1 in the range of between 0.0001 inches and 0.004 inches, while the third corrosion resistant coating 66 may have a thickness T2 in the range of between 0.0001 inches and 0.005 inches. In the illustrated embodiment, the channel member 72 is shown as coated on both sides with the first and third corrosion resistant coatings 16, 66. It will be appreciated, however, that in some embodiments only a single side may be coated.

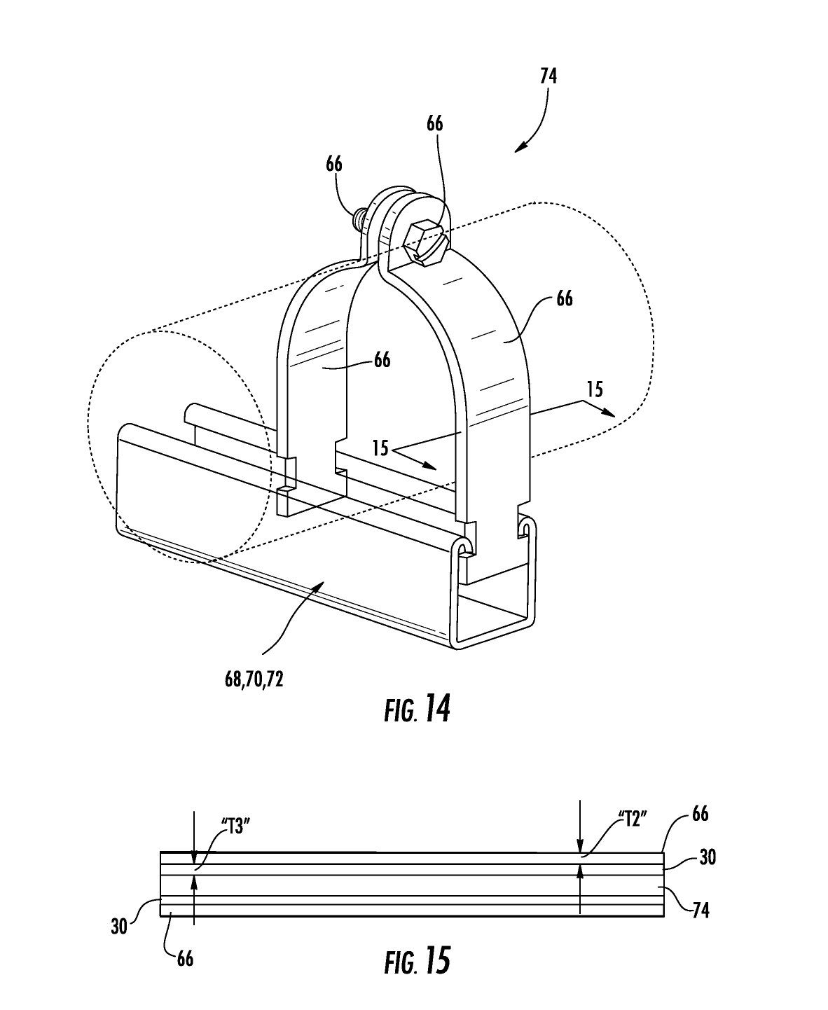

FIG. 14 shows an additional embodiment in which the third corrosion resistant coating 66 is applied over the second corrosion resistant coating 30 of an exemplary pipe/conduit support fitting 74 similar to that described in relation to FIG. 3. FIG. 15 shows a cross-section view of the coating building on the exemplary pipe/conduit support fitting 74. In some embodiments, the second corrosion resistant coating 30 may have a thickness T3 in the range of between 0.0001 inches and 0.002 inches, while the third corrosion resistant coating 66 may have a thickness T2 in the range of between 0.0001 inches and 0.005 inches. In the illustrated embodiment, the channel member 72 is shown as coated on both sides with the second and third corrosion resistant coatings 30, 66. It will be appreciated, however, that in some embodiments, only a single side may be coated.

It will be appreciated that although FIGS. 14 and 15 illustrate the third corrosion resistant coating 66 applied over the second corrosion resistant coating 30 of a pipe/conduit support fitting 74, that the third corrosion resistant coating can also be applied over the second corrosion resistant coating of other fittings such as beam clamps, plate fittings, clamp fittings, channels nuts, coupler nuts, threaded rods, and the like.

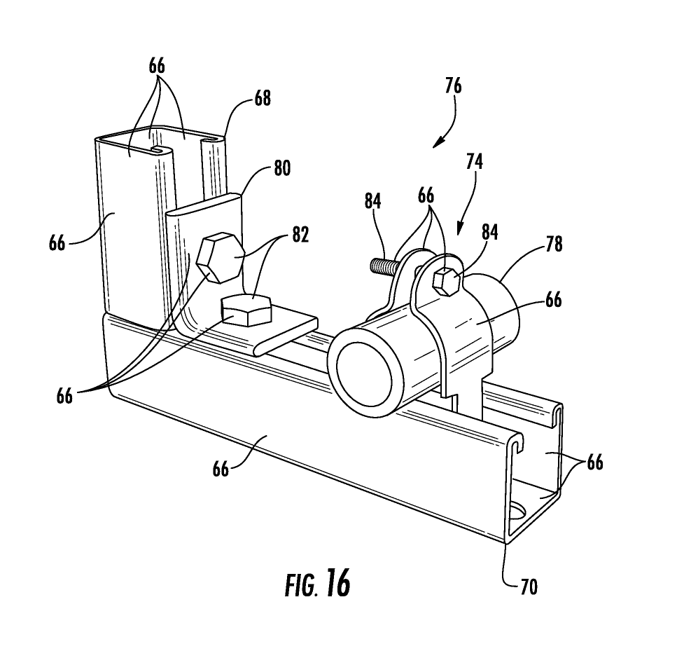

FIG. 16 shows an exemplary support assembly 76 for supporting a length of pipe/conduit 78. The support assembly 76 includes first and second channel members 68, 70, a plate fitting 80 coupling the first and second channel members at a 90-degree angle via mechanical fasteners 82 and first and second channel nuts (not visible). A support fitting 74, including a mechanical fastener 84, engages a channel portion of the channel member 70 to couple the pipe/conduit 78 thereto. The first and second channel members 68, 70 may include a corrosion resistant coating first and third corrosion resistant coatings 16, 66 on all exterior surfaces thereof (first corrosion resistant coating 16 not being visible in this view). In one embodiment, the first corrosion resistant coating 16 is a zinc-aluminum-magnesium coating. Likewise, the plate fitting 80, support fitting 74, and mechanical fasteners 82, 84 may all include second and third corrosion resistant coatings 30, 66 on all exterior surfaces thereof (second corrosion resistant coating 30 not being visible in this view). In one embodiment, the corrosion resistant coating 30 is a thermal diffusion galvanizing coating.

Although the disclosure refers to certain channel members, certain fittings and certain fasteners, one of ordinary skill in the art will appreciate that the disclosed corrosion resistant system can employ any of a variety of support, fitting and fastener members.

In addition, although the system has been described in relation to channels, and systems constructed from channels, it will be appreciated that it is equally applicable to other applications including cable trays, conduit, and telescoping channel.

Based on the foregoing information, it will be readily understood by those persons skilled in the art that the disclosed arrangement is susceptible of broad utility and application. Many embodiments and adaptations of the disclosed arrangement other than those specifically described herein, as well as many variations, modifications, and equivalent arrangements, will be apparent from or reasonably suggested by the disclosed arrangement and the foregoing descriptions thereof, without departing from the substance or scope of the disclosure. Accordingly, while the disclosed arrangement has been described herein in detail in relation to its preferred embodiment, it is to be understood that this disclosure is only illustrative and exemplary and is made merely for the purpose of providing a full and enabling disclosure. The foregoing disclosure is not intended to be construed to limit or otherwise exclude any such other embodiments, adaptations, variations, modifications or equivalent arrangements; the disclosure being limited only by the claims appended hereto and the equivalents thereof Although specific terms are employed herein, they are used in a generic and descriptive sense only and not for the purpose of limitation.

What is claimed is:

1. A corrosion resistant support system, comprising:
a first channel member;
a fitting engaged with said channel member; and
a first mechanical fastener coupling the fitting to the channel member;
wherein the first channel member comprises steel having a zinc-aluminum-magnesium coating; and
wherein the fitting and the first mechanical fastener comprise steel having a thermal diffusion galvanized coating.

2. The support system of claim 1, further comprising a second channel member coupled to the first channel member via said fitting and a second mechanical fastener, wherein the second channel member comprises steel having said zinc-aluminum-magnesium coating and the second mechanical fastener comprises steel having said thermal diffusion galvanized coating.

3. The support system of claim 1, wherein the fitting is selected from the list consisting of a beam clamp, and a conduit support.

4. The support system of claim 1, wherein the mechanical fastener is selected from the list consisting of a nut, a cap screw, a bolt, a channel nut, a coupler nut, a threaded rod, and a lock washer.

5. A corrosion resistant support system, comprising:
a plurality of steel support members having a zinc-aluminum-magnesium coating; and
a plurality of steel mechanical fasteners and a plurality of steel fittings having a thermal diffusion galvanized coating;
wherein the corrosion resistant support system is selected from the list consisting of a cable tray and a telescoping channel.

6. A corrosion resistant support system, comprising:
a first channel member having a first corrosion resistant coating, the first corrosion resistant coating comprising a zinc-aluminum-magnesium coating; and
a fitting engageable with said channel member and a first mechanical fastener for coupling the fitting to the channel member, the fitting and the first mechanical fastener each having a second corrosion resistant coating, the second corrosion resistant coating comprising a thermal diffusion galvanized coating;
wherein the first channel member and the first mechanical fastener further have a third corrosion resistant coating disposed over the first and second corrosion resistant coatings, respectively.

7. The support system of claim 6, wherein the third corrosion resistant coating is selected from the list consisting of a Perma-Green™ coating, a powder coating, an electrocoating (E-coat or Electrophoretic deposition coating), a paint coating, an epoxy coating, a polyvinyl chloride (PVC) coating, a trivalent chromium coating, a hexavalent chromium coating, a zinc coating, and a copper coating.

8. The support system of claim 6, further comprising a second channel member coupled to the first channel member via said fitting and a second mechanical fastener, wherein the second channel member has said first and third corrosion resistant coatings thereon, and the second mechanical fastener has said second and third corrosion resistant coatings thereon.

9. The support system of claim 6, wherein the fitting is selected from the list consisting of a beam clamp and a conduit support.

10. The support system of claim 6, wherein the mechanical fastener is selected from the list consisting of a nut, a cap screw, a bolt, a channel nut, a coupler nut, a threaded rod and a lock washer.

11. A corrosion resistant support system, comprising:
a plurality of steel support members having a zinc-aluminum-magnesium coating; and
a plurality of steel mechanical fasteners and a plurality of steel fittings having a thermal diffusion galvanized coating or a zinc-aluminum-magnesium coating;
wherein the plurality of steel support members include a third corrosion resistant coating applied over the zinc-aluminum-magnesium coating;
wherein the plurality of steel mechanical fasteners and the plurality of steel fittings include the third corrosion resistant coating applied over the thermal diffusion galvanized coating; and
wherein the corrosion resistant support system is selected from the list consisting of a cable tray and a telescoping channel.

12. The support system of claim 11, wherein the third corrosion resistant coating is selected from the list consisting of a Perma-Green™ coating, a powder coating, an electrocoating (E-coat or Electrophoretic deposition coating), a paint coating, an epoxy coating, a polyvinyl chloride (PVC) coating, a trivalent chromium coating, a hexavalent chromium coating, a zinc coating, and a copper coating.
